(19) United States
(12) Patent Application Publication
(10) Pub. No.: US 2023/0383674 A1
(43) Pub. Date: Nov. 30, 2023

(54) RADIAL TURBINE HAVING A CLEANING DEVICE FOR CLEANING A GUIDE VANE RING AND METHODS FOR MOUNTING AND DEMOUNTING THE CLEANING DEVICE

(71) Applicant: TURBO SYSTEMS SWITZERLAND LTD., Baden (CH)

(72) Inventors: Stefan GANTERT, Lottstetten (DE); Thomas RECHIN, Baden (CH); Tobias VOGT, Rickenbach (DE); Matthias RICHNER, Riniken (CH); Magnus FISCHER, Zürich (CH); Markus LOOS, Baden (CH)

(21) Appl. No.: 18/031,532

(22) PCT Filed: Sep. 23, 2021
(86) PCT No.: PCT/EP2021/076216

§ 371 Date: Apr. 12, 2023

(30) Foreign Application Priority Data
Oct. 13, 2020 (EP) 20201552.5

(51) Int. Cl. F01D 25/00; F01D 9/04

(52) U.S. Cl. CPC F01D 25/002; F01D 9/045; F05D 2240/128; F05D 2220/40; F05D 2230/72

(57) ABSTRACT

The invention relates to a radial turbine. The radial turbine comprises: —a turbine housing having a radial gas inflow channel; —a nozzle ring, which is disposed in the radial gas inflow channel; and —an annular cleaning device for cleaning the nozzle ring. The annular cleaning device is connected to a cleaning-agent feed by means of an axially insertion-connectable supply line such that, after or during the demounting of the nozzle ring, the annular cleaning device can be removed from the turbine housing in the axial direction. The invention also relates to a method for mounting a cleaning device for cleaning a nozzle ring of a radial turbine and to a method for demounting the cleaning device.

### TECHNICAL FIELD

The invention relates to the field of exhaust gas turbines, in particular radial turbines, for example, for an exhaust gas turbocharger. In particular, the invention relates to a radial turbine having a cleaning device for cleaning a nozzle ring. The invention furthermore relates to a device for mounting a cleaning device for cleaning a nozzle ring of a radial turbine and a method for dismounting the cleaning device.

### TECHNICAL BACKGROUND

Exhaust gas turbochargers, having a turbine in the exhaust tract of the internal combustion engine and having a compressor arranged upstream of the internal combustion engine, are nowadays used as standard to improve the performance of an internal combustion engine. The exhaust gases of the internal combustion engine are relieved of pressure in the turbine. The work obtained thereby is transmitted by means of a shaft to the compressor which compresses the air supplied to the internal combustion engine. As a result of the use of the energy of the exhaust gases for the compression of the air supplied to the combustion process in the internal combustion engine, the combustion process and the efficiency of the internal combustion engine can be optimized.

The kinetic energy of the exhaust gas is used to drive the rotor of the turbocharger. In order to be able to ensure reliable operation, the exhaust gas flow must be fed in a targeted manner to the turbine shaft. For this purpose and to enable a “matching” of the turbocharger for various applications, a nozzle ring is installed in the case of radial turbine stages at the outlet of the flow channel in front of the turbine shaft.

Cleaning devices are used in order to maintain the turbine-side performance and for protection from excessive contamination with associated operating problems at the turbocharger. This is performed partially with water, but also with dry cleaning agents.

Above all, the nozzle ring is significantly impacted by contamination, which can lead to significant operating restrictions. During maintenance of the turbocharger and in particular during mechanical cleaning of the nozzle ring, the cleaning device must also be checked for blockages and operation of the nozzles. In this case, it must be dismounted from the turbocharger.

The mounting or dismounting of the cleaning devices known from the prior art for nozzle rings is relatively complex, which leads to relatively high maintenance outlay.

The object of the present invention lies in providing a radial turbine having a cleaning device which is improved at least in terms of one of the disadvantages known from the prior art. In particular, one object of the present invention is to provide a cleaning device for a nozzle ring of a radial turbine which can be mounted and dismounted more easily than in the prior art. A further object of the present invention is to provide an improved mounting and dismounting method for a cleaning device for cleaning a nozzle ring of a radial turbine so that the maintenance outlay can be reduced in comparison with the prior art.

### BRIEF DESCRIPTION OF THE INVENTION

A radial turbine having a cleaning device, a method for mounting a cleaning device, and a method for dismounting a cleaning device according to the independent claims are provided in order to achieve the above-mentioned objects. Further aspects, advantages and features of the present invention can be inferred from the dependent claims, the description and the enclosed figures.

According to a first aspect of the invention, a radial turbine is provided. The radial turbine comprises a turbine housing with a radial gas inflow channel. The radial turbine furthermore comprises a nozzle ring which is arranged in the radial gas inflow channel. The radial turbine further comprises an annular cleaning device for cleaning the nozzle ring. The annular cleaning device is connected to a cleaning agent feed via an axially pluggable supply line so that, after or with dismounting of the nozzle ring, the annular cleaning device can be removed from the turbine housing in the axial direction.

A radial turbine having a cleaning device for cleaning a nozzle ring is thus advantageously provided which is improved over the prior art. In particular, the cleaning device is advantageously configured such that it can be easily mounted and dismounted so that the maintenance outlay is reduced in comparison with the prior art.

A second aspect of the invention relates to an exhaust gas turbocharger having a radial turbine according to embodiments described herein.

A third aspect of the invention relates to a method for mounting a cleaning device for cleaning a nozzle ring of a radial turbine. The method comprises an axial pushing-in of the annular cleaning device into a corresponding receptacle of a turbine housing of the radial turbine. The method further comprises an axial connection of the annular cleaning device to a cleaning agent feed via an axially pluggable supply line. The method further comprises a fixing of the annular cleaning device by means of a fixing of the nozzle ring in particular so that the annular cleaning device is fixed exclusively via the fixing of the nozzle ring with respect to the turbine housing.

A fourth aspect of the invention relates to a method for dismounting a cleaning device for cleaning a nozzle ring of a radial turbine. The method comprises a release of a fixing of the nozzle ring. The method furthermore comprises a release of an axial plug-in connection in a supply line from a cleaning agent feed to the annular cleaning device. The method further comprises an axial removal of the annular cleaning device. In particular, exclusively the fixing of the nozzle ring and the axial plug-in connection in the supply line are to be released for axial removal of the annular cleaning device.

### BRIEF DESCRIPTION OF THE FIGURES

The invention should be explained below on the basis of exemplary embodiments represented in figures, from which exemplary embodiments further advantages and modifications arise. In the figures:

FIG. 1 shows a schematic sectional view along the central axis of a radial turbine having a cleaning device in an installed state according to embodiments described herein;

FIG. 2 shows a schematic three-dimensional view of a radial turbine according to embodiments described herein with a dismounted cleaning device and a dismounted nozzle ring;

FIGS. 3a to 3f show schematic sectional views of an annular cleaning device for cleaning a nozzle ring according to embodiments described herein;

FIG. 4 shows a schematic sectional view along the central axis of a radial turbine having a cleaning device for cleaning a nozzle ring comprising at least one compensation element for compensation of thermal expansions according to embodiments described herein;

FIG. 5a shows a schematic sectional view of an annular cleaning device mounted in the turbine housing;

FIG. 5b shows a schematic sectional view of an annular cleaning device during mounting/dismounting (see double-sided arrow);

FIG. 6 shows a block diagram to illustrate a method for mounting a cleaning device according to embodiments described herein; and

FIG. 7 shows a block diagram to illustrate a method for dismounting a cleaning device according to embodiments described herein.

### DETAILED DESCRIPTION OF THE FIGURES

Various embodiments are described below, of which one or more examples are represented in each illustration. Each example serves the purpose of explanation and is not to be regarded as a restriction. For example, features which are represented or described as part of an embodiment can be used in combination with any other embodiment in order to obtain a further embodiment. It is intended that the present disclosure encompasses such modifications and variations.

In the following description of the drawing, identical reference numbers relate to identical or similar components. Only the differences in relation to the individual embodiments are generally described. Unless indicated otherwise, the description of one part or aspect in one embodiment can relate to a corresponding part or a corresponding aspect in another embodiment.

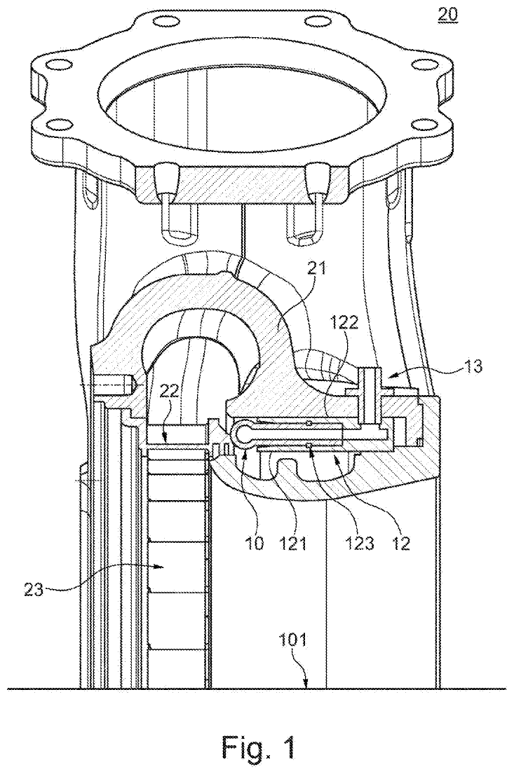

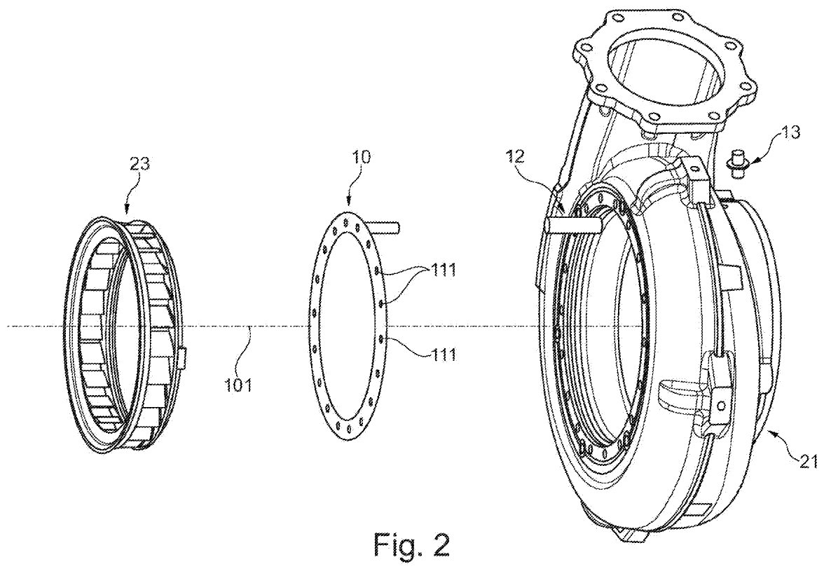

A radial turbine 20 having a cleaning device 10 according to the present disclosure is described with reference to FIGS. 1 and 2. FIG. 1 shows a schematic side view along the central axis 101 of the radial turbine 20 with a cleaning device in an installed state. FIG. 2 shows a schematic view of the radial turbine 20 with dismounted nozzle ring 23 and dismounted cleaning device 10.

According to one embodiment which can be combined with other embodiments described herein, the radial turbine 20 comprises a turbine housing 21 with a radial gas inflow channel 22. The radial turbine 20 furthermore comprises a nozzle ring 23 which is arranged in the radial gas inflow channel 22. The radial turbine 20 further comprises an annular cleaning device 10 for cleaning the nozzle ring 23. The annular cleaning device 10 is connected to a cleaning agent feed 13 via an axially pluggable supply line 12 in such a manner that after or with dismounting of the nozzle ring 23 the annular cleaning device 10 can be removed from the turbine housing 21 in the axial direction. In particular, the annular cleaning device 10 is mounted in the turbine housing 21 in such a manner that the annular cleaning device 10 can be dismounted without releasing external connection or mounting elements. The term “external connection or mounting elements” should be understood as those connection or mounting elements which, in the mounted state, are located at least partially outside the turbine housing.

A radial turbine having a cleaning device for cleaning a nozzle ring can thus advantageously be provided which is advantageously configured such that it can be easily mounted and dismounted so that the maintenance outlay is reduced in comparison with the prior art.

According to one embodiment which can be combined with other embodiments described herein, the annular cleaning device 10 comprises several cleaning agent openings 111 arranged over the circumference, as is represented by way of example in FIG. 2.

According to one embodiment which can be combined with other embodiments described herein, the annular cleaning device 10 is fixed in the axial direction exclusively via a fixing of the nozzle ring 23 in the turbine housing 21. In other words, the fixing of the nozzle ring 23 fixes the axial position of the cleaning device 10 in relation to the turbine housing 21, wherein no additional fixing is provided for fixing the axial position of the cleaning device 10.

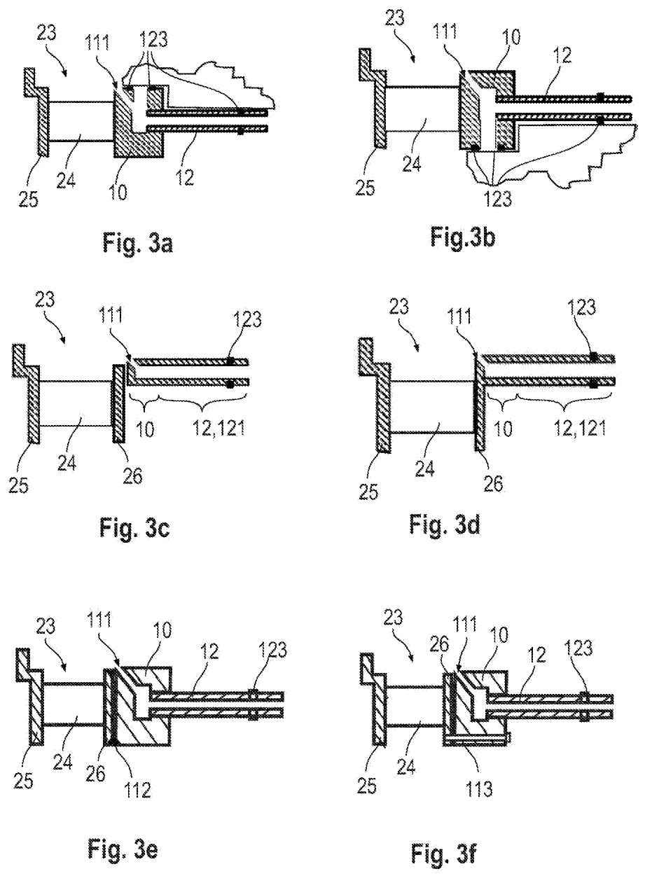

According to one embodiment which can be combined with other embodiments described herein, the nozzle ring 23 can be a nozzle ring which is open on one side. The nozzle ring which is open on one side typically has guide vanes 24 which extend from a bearing housing-side annular disc 25 in the axial direction, as is represented by way of example in FIG. 3a. In a mounted state, the guide vanes 24 can be in contact with the annular cleaning device 10. According to one example, the annular cleaning device 10 can have receptacles (not represented explicitly in the figures) for the guide vanes 24.

According to one alternative embodiment, there is no contact between the guide vanes 24 and the annular cleaning device 10. It should be noted in this context that the annular cleaning device 10 can be fixed by means of inner fixing elements in the turbine housing 21. The term “inner fixing elements” should be understood as those fixing elements which, in the mounted state, are arranged entirely inside the turbine housing.

According to one embodiment which can be combined with other embodiments described herein, the nozzle ring 23 is a closed nozzle ring with guide vanes 24 which are embodied to be integral with the annular cleaning device 10.

As is represented by way of example in FIGS. 3a and 3b, the annular cleaning device 10 can be formed separately from the supply line 12. Alternatively, the annular cleaning device 10 can be formed integrally with the supply line, as is represented by way of example in FIGS. 3c and 3d.

According to one embodiment which can be combined with other embodiments described herein, the nozzle ring 23 is a closed nozzle ring with guide vanes 24 which are arranged between a bearing housing-side annular disc 25 and a turbine housing-side annular disc 26, as is represented by way of example in FIGS. 3c-3f The annular cleaning device 10 can be connected to the turbine housing-side annular disc 26. For example, the annular cleaning device 10 can be connected by means of a screw connection 113 to the turbine housing-side annular disc 26, as is represented by way of example in FIG. 3f Alternatively, the annular cleaning device can be connected by means of a welded connection 112 to the turbine housing-side annular disc 26, as is represented by way of example in FIG. 3e.

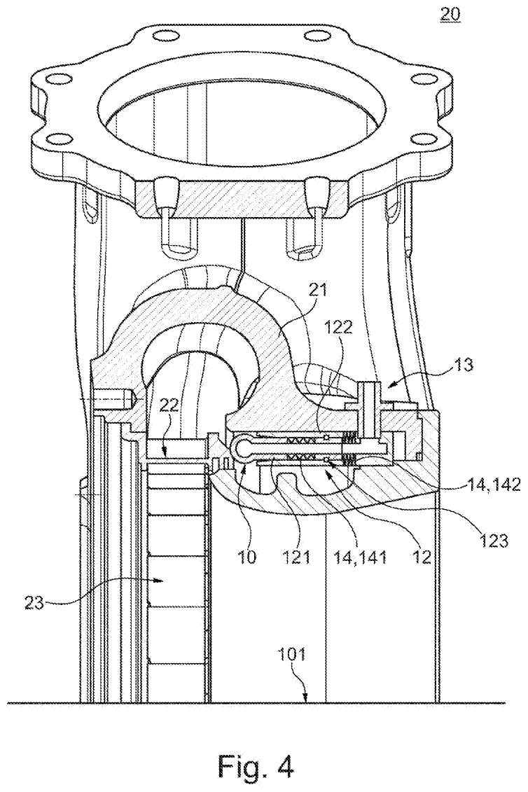

According to one embodiment which can be combined with other embodiments described herein, the axially pluggable supply line 12 is formed by means of a plug-in tube 121 and a plug-in sleeve 122, as is represented by way of example in FIGS. 1 and 4. The plug-in tube 121 and the plug-in sleeve 122 are typically sealed off from one another by means of one or more seal elements 123, in particular by means of one or more sealing rings. The plug-in tube 121 is typically connected to the annular cleaning device 10. For example, the plug-in tube 121 can be embodied to be integral with the annular cleaning device, as is represented by way of example in FIGS. 3c and 3d.

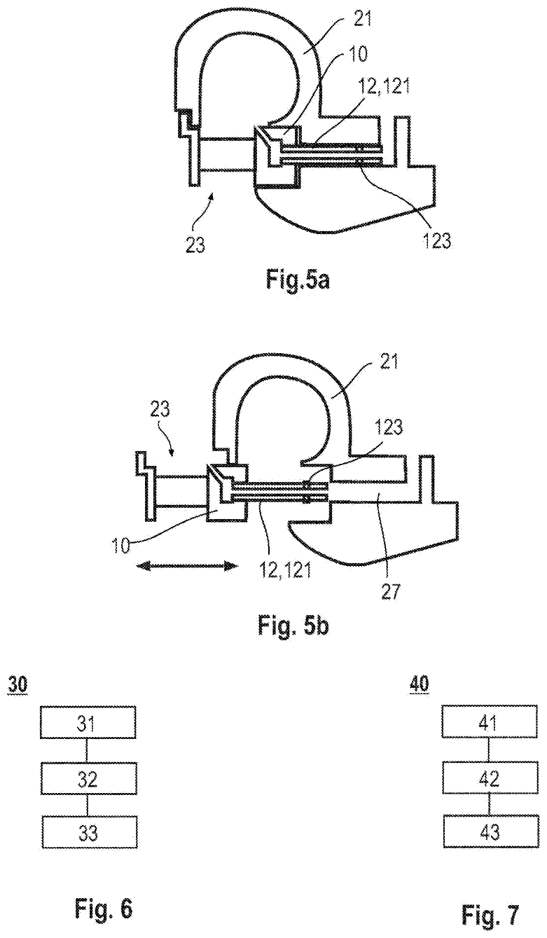

With reference to FIGS. 5a and 5b, the plug-in supply line 12 according to an alternative embodiment which can be combined with other embodiments described herein can be provided by a plug-in tube 121 and a corresponding receptacle 27 provided in the turbine housing 21. In the mounted state, the plug-in tube 121 is typically sealed off from the corresponding receptacle 27 provided in the turbine housing 21 by means of one or more seal elements 123, in particular by means of one or more sealing rings.

According to one embodiment which can be combined with other embodiments described herein, the axially pluggable supply line 12 comprises at least one compensation element 14 for compensation of thermal expansions, as is represented by way of example in FIG. 4. For example, the at least one compensation element 14 can be a bellows. The at least one compensation element 14 can be part of the plug-in tube and/or the plug-in sleeve. For example, the at least one compensation element 14 can comprise a first compensation element 141, which is represented by way of example in FIG. 4 as part of the plug-in tube 121. Alternatively or additionally, the at least one compensation element 14 can comprise a second compensation element 142, which is represented by way of example in FIG. 4 as part of the plug-in sleeve 122. Both the first compensation element 141 and the second compensation element 142 can be formed as bellows.

According to a first aspect of the invention, the radial turbine according to the embodiments described herein is used for an exhaust gas turbocharger so that an exhaust gas turbocharger having a radial turbine according to the embodiments described herein is provided.

A further aspect of the invention relates to a method 30 for mounting a cleaning device 10 for cleaning a nozzle ring 23 of a radial turbine 20. The method for mounting the cleaning device is illustrated schematically by the block diagram represented in FIG. 6. According to one embodiment which can be combined with other embodiments described herein, the method 30 comprises an axial pushing-in (represented schematically by block 31 in FIG. 6) of the annular cleaning device 10 into a corresponding receptacle of a turbine housing 21 of the radial turbine 20. The method 30 further comprises an axial connection (represented schematically by block 32 in FIG. 6) of the annular cleaning device 10 to a cleaning agent feed 13 via an axially pluggable supply line 12. The method 30 further comprises a fixing (represented schematically by block 33 in FIG. 6) of the annular cleaning device 10 by means of a fixing of the nozzle ring, in particular so that the annular cleaning device 10 is fixed exclusively via the fixing of the nozzle ring with respect to the turbine housing.

A further aspect of the invention relates to a method 40 for dismounting a cleaning device 10 for cleaning a nozzle ring 23 of a radial turbine 20. The method 40 for dismounting the cleaning device is illustrated schematically by the block diagram represented in FIG. 7. According to one embodiment which can be combined with other embodiments described herein, the method 40 comprises a release (represented schematically by block 41 in FIG. 7) of a fixing of the nozzle ring. The method further comprises a release (represented schematically by block 42 in FIG. 7) of an axial plug-in connection in a supply line 12 from a cleaning agent feed 13 to the annular cleaning device. The method further comprises an axial removal (represented schematically by block 43 in figure) of the annular cleaning device. In particular, for axial removal 42 of the annular cleaning device exclusively the fixing of the nozzle ring and the axial plug-in connection in the supply line 12 are to be released.

It should be noted that the method 30 for mounting and the method 40 for dismounting a cleaning device typically involve the cleaning device 10 for cleaning a nozzle ring 23 of a radial turbine 20 according to any one of the embodiments described herein.

### LIST OF REFERENCE NUMBERS

10 Annular cleaning device
101 Central axis
111 Cleaning agent openings
112 Welded connection
113 Screw connection
12 Axially pluggable supply line
121 Plug-in tube
122 Plug-in sleeve
123 Sealing element(s)
13 Cleaning agent feed
14 Compensation element
141 First compensation element
142 Second compensation element
20 Radial turbine
21 Turbine housing
22 Radial gas inflow channel
23 Nozzle ring
24 Guide vanes
25 Bearing housing-side annular disc
26 Turbine housing-side annular disc
27 Receptacle in the turbine housing
30 Method for mounting a cleaning device
31, 32, 33 Blocks of the block diagram to illustrate the method for mounting the cleaning device
40 Method for dismounting a cleaning device
41, 42, 43 Blocks of the block diagram to illustrate the method for dismounting the cleaning device

1. A radial turbine, comprising:
a turbine housing having a radial gas inflow channel;
a nozzle ring which is arranged in the radial gas inflow channel; and
an annular cleaning device for cleaning the nozzle ring, wherein the annular cleaning device is connected to a cleaning agent feed via an axially pluggable supply line, so that, after or with dismounting of the nozzle ring, the annular cleaning device can be removed from the turbine housing in the axial direction.

2. The radial turbine as claimed in claim 1, wherein the annular cleaning device is fixed in the axial direction exclusively via a fixing of the nozzle ring in the turbine housing.

3. The radial turbine as claimed in claim 1, wherein the nozzle ring is a nozzle ring which is open on one side having guide vanes, wherein the guide vanes extend from a bearing housing-side annular disc in the axial direction, and wherein the guide vanes in the mounted state are in contact with the annular cleaning device.

4. The radial turbine as claimed in claim 3, wherein the annular cleaning device has receptacles for the guide vanes.

5. The radial turbine as claimed in claim 1, wherein the nozzle ring is a closed nozzle ring having guide vanes, wherein the guide vanes are embodied to be integral with the annular cleaning device.

6. The radial turbine as claimed in claim 1, wherein the nozzle ring is a closed nozzle ring having guide vanes, wherein the guide vanes are arranged between a bearing housing-side annular disc and a turbine housing-side annular disc, and wherein the annular cleaning device is connected to the turbine housing-side annular disc.

7. The radial turbine as claimed in claim 1, wherein the annular cleaning device comprises several cleaning agent openings arranged over the circumference.

8. The radial turbine as claimed in claim 1, wherein the axially pluggable supply line is formed by means of a plug-in tube and a plug-in sleeve which are sealed off from one another by means of one or more seal elements.

9. The radial turbine as claimed in claim 8, wherein the plug-in tube is connected to the annular cleaning device.

10. The radial turbine as claimed in claim 1, wherein the axially pluggable supply line comprises at least one compensation element for compensation of thermal expansions.

11. The radial turbine as claimed in claim 1, wherein the axially pluggable supply line is formed by means of a plug-in tube and a plug-in sleeve which are sealed off from one another by means of one or more seal elements, wherein the axially pluggable supply line comprises at least one compensation element for compensation of thermal expansions, and wherein the at least one compensation element is part of at least one of the plug-in tube and/or the plug-in sleeve.

12. An exhaust gas turbocharger having a radial turbine, the radial turbine comprising:
a turbine housing having a radial gas inflow channel;
a nozzle ring which is arranged in the radial gas inflow channel; and
an annular cleaning device for cleaning the nozzle ring, wherein the annular cleaning device is connected to a cleaning agent feed via an axially pluggable supply line, so that, after or with dismounting of the nozzle ring, the annular cleaning device can be removed from the turbine housing in the axial direction.

13. A method for mounting a cleaning device for cleaning a nozzle ring of a radial turbine, comprising:
axial pushing-in of the annular cleaning device into a corresponding receptacle of a turbine housing of the radial turbine;
axial connecting of the annular cleaning device to a cleaning agent feed via an axially pluggable supply line; and
fixing the annular cleaning device by means of a fixing of the nozzle ring.

14. A method for dismounting an annular cleaning device for cleaning a nozzle ring of a radial turbine, comprising:
releasing a fixing of the nozzle ring,
releasing an axial plug-in connection in a supply line from a cleaning agent feed to the annular cleaning device; and
axial removal of the annular cleaning device.

15. The radial turbine as claimed in claim 1, wherein the nozzle ring is a closed nozzle ring having guide vanes, wherein the guide vanes are arranged between a bearing housing-side annular disc and a turbine housing-side annular disc, and wherein the annular cleaning device is connected to the turbine housing-side annular disc by means of a connection selected from a screw connection and a welded connection.

16. The radial turbine as claimed in claim 1, wherein the axially pluggable supply line is formed by means of a plug-in tube and a plug-in sleeve which are sealed off from one another by means of one or more sealing rings.

17. The radial turbine as claimed in claim 8, wherein the plug-in tube is embodied to be integral with the annular cleaning device.

18. The radial turbine as claimed in claim 10, wherein the at least one compensation element is a bellows.

19. The method of claim 13, fixing the annular cleaning device by means of a fixing of the nozzle ring is done so that the annular cleaning device is fixed exclusively via the fixing of the nozzle ring with respect to the turbine housing.

20. The method of claim 14, wherein for axial removal of the annular cleaning device exclusively the fixing of the nozzle ring and the axial plug-in connection in the supply line are to be released.
